(19) United States
(12) Patent Application Publication
(10) Pub. No.: US 2026/0297381 A1
(43) Pub. Date: Oct. 1, 2026

(54) METHOD FOR PRODUCING DISPERSION LIQUID CONTAINING COLLOIDAL SILICA PARTICLES

(71) Applicant: FUJIMI INCORPORATED, Kiyosu-shi (JP)

(72) Inventors: Masaki Tada, Kiyosu-shi (JP); Natsuko Oshima, Kiyosu-shi (JP); Daichi Jimbo, Kiyosu-shi (JP)

(73) Assignee: FUJIMI INCORPORATED, Kiyosu-shi (JP)

(21) Appl. No.: 19/546,524

(22) Filed: Feb. 23, 2026

(30) Foreign Application Priority Data
Mar. 31, 2025 (JP) 2025-057573

(51) Int. Cl. C09G 1/02; C09C 1/30; C09K 3/14

(52) U.S. Cl. CPC C09G 1/02; C09C 1/3045; C09C 1/3063; C09C 1/3072; C09C 1/309; C09K 3/1436

(57) ABSTRACT

A method for producing a dispersion liquid containing colloidal silica particles according to the present disclosure includes an ion exchange step of bringing a liquid containing colloidal silica particles and hydrogen peroxide into contact with an ion exchange resin.

### TECHNICAL FIELD

The present disclosure relates to a method for producing a dispersion liquid containing colloidal silica particles.

### BACKGROUND ART

Conventionally, material surfaces of metals, semimetals, nonmetals, and oxides thereof, and the like are subjected to chemical mechanical polishing (CMP) using a polishing composition. In general, the polishing composition has a structure in which particles (abrasive grains) having a function of mechanical polishing are mixed with and dispersed in an aqueous solution having a function of chemical polishing, and colloidal silica particles are known to be used as abrasive grains.

In the production process of a dispersion liquid containing colloidal silica particles, hydrogen peroxide is added to the dispersion liquid to increase an antifungal effect. In addition, Japanese unexamined Patent Application Publication No. 2020-075830 discloses a method for producing a silica sol including a step of hydrolyzing and condensing tetraalkoxysilane to obtain a silica sol reaction liquid, and a step of adding an oxidizing agent containing hydrogen peroxide to the silica sol reaction liquid, to reduce intermediate products in the production process of colloidal silica (silica sol).

### SUMMARY

Hydrogen peroxide used in the production process of the dispersion liquid containing colloidal silica particles, the production process of colloidal silica, and the like unfortunately generates by-products through reaction with the residue of a component (e.g., an organic solvent such as methanol) used in the production process.

Thus, an object of the present disclosure is to provide a method for producing a dispersion liquid containing colloidal silica particles, capable of reducing the content of the by-product produced by hydrogen peroxide.

The inventors of the present disclosure have intensively studied in view of the above problem. As a result, the inventors have found that the above object can be solved by a method for producing a dispersion liquid containing colloidal silica particles, including an ion exchange step of bringing a liquid containing colloidal silica particles and hydrogen peroxide into contact with an ion exchange resin, and completed the invention of the present disclosure.

### DESCRIPTION OF EMBODIMENTS

Hereinafter, the embodiments according to one aspect of the present disclosure will be described. The present disclosure is not limited to the following embodiments.

As used herein, “X to Y” indicating a range means “X or more and Y or less”. Unless otherwise indicated, the operation and the measurement of physical properties and the like are performed under the conditions of room temperature (20 to 25° C.)/relative humidity of 40 to 50% RH.

### <Method for Producing Dispersion Liquid Containing Colloidal Silica Particles>

One aspect of the present disclosure is a method for producing a dispersion liquid containing colloidal silica particles, including an ion exchange step of bringing a liquid containing colloidal silica particles and hydrogen peroxide into contact with an ion exchange resin. The method for producing a dispersion liquid containing colloidal silica particles according to the present aspect can reduce a by-product produced by hydrogen peroxide.

### [Ion Exchange Step]

The method for producing a dispersion liquid containing colloidal silica particles according to the present aspect includes the ion exchange step of bringing a liquid containing colloidal silica particles and hydrogen peroxide into contact with an ion exchange resin.

The ion exchange step may be conducted once, or if necessary, twice or more.

As used herein, “the liquid containing colloidal silica particles and hydrogen peroxide” may be simply referred to as “the liquid according to the present aspect”.

The liquid according to the present aspect contains colloidal silica particles. The colloidal silica particles may be colloidal silica particles produced by an alkoxide method or colloidal silica particles produced by a sodium silicate method. From the viewpoint of reducing metal impurities, the colloidal silica particles are preferably colloidal silica particles produced by the alkoxide method.

The alkoxide method is typically a method in which an alkoxysilane used as a raw material is subjected to a hydrolysis and condensation reaction. Examples of the alkoxide method include a method in which an alkoxysilane or a condensate thereof and water are reacted in the presence of an alkali catalyst in a reaction liquid containing the alkoxysilane or the condensate thereof, water, and the alkali catalyst to synthesize colloidal silica (a raw material liquid containing colloidal silica particles).

As the alkoxysilane or the condensate thereof, a known one can be used without particular limitation. The alkoxysilane condensate may be, for example, 2 to 12-mer, and is preferably 4 to 8-mer. Examples of the alkoxysilane include tetramethoxysilane, tetraethoxysilane, and tetrapropoxysilane. From the viewpoint of having an appropriate hydrolysis reactivity, the alkoxysilane is preferably tetramethoxysilane. The alkoxysilane or the condensate thereof may be used alone or in combination of two or more.

As the water, pure water or ultrapure water is preferably used, from the viewpoint of reducing the contamination of metal impurities and the like as much as possible.

As the organic solvent, a hydrophilic organic solvent is preferably used, and specific examples thereof include alcohols such as methanol, ethanol, n-propanol, isopropanol, ethylene glycol, propylene glycol, and 1,4-butanediol; and ketones such as acetone and methyl ethyl ketone. The organic solvent is preferably an alcohol, and from the viewpoint of recovering and reusing the organic solvent, the same type of alcohol as the alcohol produced by the hydrolysis of the alkoxysilane is preferably used. For example, when tetramethoxysilane is used as the alkoxysilane, the organic solvent is preferably methanol.

As the alkali catalyst, a conventionally known one may be used. From the viewpoint of being capable of reducing the contamination of metal impurities and the like as much as possible, the alkali catalyst is preferably at least one selected from the group consisting of ammonia, tetramethyl ammonium hydroxide, and other ammonium salts. Among these, ammonia is more preferable, from the viewpoint of an excellent catalytic action. The alkali catalyst may be used alone or in combination of two or more.

In one embodiment, a method for synthesizing colloidal silica (the raw material liquid containing colloidal silica particles) includes reacting tetramethoxysilane and water in the presence of ammonia in a reaction liquid containing tetramethoxysilane, water, and ammonia.

As the method for synthesizing colloidal silica (the raw material liquid containing colloidal silica particles) as described above, a two-part reaction type and a three-part reaction type are known. In the two-part reaction type, a liquid containing an alkoxysilane or a condensate thereof and an organic solvent (the addition side) is added to a liquid containing an alkali catalyst, water, and an organic solvent (the receiving side). In the two-part reaction type, the liquid containing an alkali catalyst, water, and an organic solvent on the receiving side contains the entire water, which is one of rate-determining factors of the reaction. On the other hand, in the three-part reaction type, a liquid containing an alkoxysilane or a condensate thereof and an organic solvent (the addition side) and a liquid containing water (the addition side) are added to a liquid containing an alkali catalyst, water, and an organic solvent (the receiving side).

Hereinafter, the method for synthesizing the two-part reaction type will be described.

As the method for synthesizing the two-part reaction type, a known method may be used without particular limitation. The method for synthesizing the two-part reaction type is preferably a synthesis method including a liquid (B) containing an alkoxysilane or a condensate thereof and a second organic solvent (as used herein, also referred to as “the liquid (B)”) is mixed with an liquid (A) containing an alkali catalyst, water, and a first organic solvent (as used herein, also referred to as “the liquid (A)”) to prepare a reaction liquid. In the reaction liquid, the alkoxysilane or the condensate thereof is subjected to hydrolysis and polycondensation to produce colloidal silica particles.

The alkali catalyst, water, the organic solvent (the first organic solvent and the second organic solvent), and the alkoxysilane or the condensate thereof are as mentioned above.

In one embodiment, the method for synthesizing the two-part reaction type includes mixing the liquid (B) containing tetramethoxysilane and methanol with the liquid (A) containing ammonia, water, and methanol to prepare a reaction liquid.

The liquid (A) contains the alkali catalyst, water, and the first organic solvent. The liquid (A) may contain other components in addition to the alkali catalyst, water, and the first organic solvent. In a preferred embodiment, the liquid (A) consists of the alkali catalyst, water, and the first organic solvent.

The lower limit of the content of the alkali catalyst in the liquid (A) is not particularly limited. The lower limit of the content of the alkali catalyst in the liquid (A) is preferably 0.1% by mass or more, more preferably 0.3% by mass or more, and further preferably 0.5% by mass or more based on the total mass of the liquid (A). The upper limit of the content of the alkali catalyst in the liquid (A) is not particularly limited. The upper limit of the content of the alkali catalyst in the liquid (A) is preferably 50% by mass or less, more preferably 40% by mass or less, and further preferably 20% by mass or less, from the viewpoint of productivity and costs. The content of the alkali catalyst in the liquid (A) is preferably 0.1% by mass or more and 50% by mass or less, more preferably 0.3% by mass or more and 40% by mass or less, and further preferably 0.5% by mass or more and 20% by mass or less based on the total mass of the liquid (A).

The lower limit of the content of water in the liquid (A) is not particularly limited, and is adjusted according to the amount of the alkoxysilane or condensate thereof to be used in the reaction. The lower limit of the content of water in the liquid (A) is preferably 1% by mass or more, more preferably 5% by mass or more, and further preferably 9% by mass or more based on the total mass of the liquid (A), from the viewpoint of the hydrolysis of the alkoxysilane. The upper limit of the content of water in the liquid (A) is not particularly limited. The upper limit of the content of water in the liquid (A) is preferably 50% by mass or less, more preferably 40% by mass or less, and further preferably 30% by mass or less based on the total mass of the liquid (A), from the viewpoint of the compatibility with the liquid (B). The content of water in the liquid (A) is preferably 1% by mass or more and 50% by mass or less, more preferably 5% by mass or more and 40% by mass or less, and further preferably 9% by mass or more and 30% by mass or less based on the total mass of the liquid (A).

The lower limit of the content of the first organic solvent in the liquid (A) is not particularly limited. The lower limit of the content of the first organic solvent in the liquid (A) is preferably 10% by mass or more, more preferably 20% by mass or more, and further preferably 50% by mass or more based on the total mass of the liquid (A), from the viewpoint of the compatibility with the liquid (B). The upper limit of the content of the first organic solvent is not particularly limited. The upper limit of the content of the first organic solvent is preferably 98% by mass or less, more preferably 95% by mass or less, and further preferably 90% by mass or less based on the total mass of the liquid (A), from the viewpoint of dispersing ability. The content of the first organic solvent is preferably 10% by mass or more and 98% by mass or less, more preferably 20% by mass or more and 95% by mass or less, and further preferably 50% by mass or more and 90% by mass or less, based on the total mass of the liquid (A).

The method for producing the liquid (A) is not particularly limited, and for example, a method in which the alkali catalyst, water, and the first organic solvent, and if necessary, other components are mixed while stirring, may be used.

The liquid (B) contains the alkoxysilane or the condensate thereof and the second organic solvent. The liquid (B) may contain other components in addition to the alkoxysilane or the condensate thereof and the second organic solvent. In a preferred embodiment, the liquid (B) consists of the alkoxysilane or the condensate thereof and the second organic solvent.

The lower limit of the content of the alkoxysilane or the condensate thereof in the liquid (B) is not particularly limited. The lower limit of the content of the alkoxysilane or the condensate thereof in the liquid (B) is preferably 50% by mass or more, more preferably 60% by mass or more, and further preferably 70% by mass or more based on the total amount (100% by mass) of the liquid (B), from the viewpoint of further increasing the content of the colloidal silica particles in the reaction liquid and further improving productivity. The upper limit of the content of the alkoxysilane or the condensate thereof in the liquid (B) is not particularly limited. The upper limit of the content of the alkoxysilane or the condensate thereof in the liquid (B) is preferably 98% by mass or less, more preferably 95% by mass or less, and further preferably 90% by mass or less based on the total mass of the liquid (B), from the viewpoint of allowing the synthesis reaction of the colloidal silica particles to further moderately proceed and further suppressing the generation of a gelatinous material, and miscibility. The content of the alkoxysilane or the condensate thereof in the liquid (B) is preferably 50% by mass or more and 98% by mass or less, more preferably 60% by mass or more and 95% by mass or less, and further preferably 70% by mass or more and 90% by mass or less.

The lower limit of the content of the second organic solvent in the liquid (B) is not particularly limited. The lower limit of the content of the second organic solvent in the liquid (B) is preferably 2% by mass or more, more preferably 5% by mass or more, and further preferably 10% by mass or more based on the total mass of the liquid (B), from the viewpoint of allowing the synthesis reaction of the colloidal silica particles to further moderately proceed and further suppressing the generation of a gelatinous material, and miscibility. The upper limit of the content of the second organic solvent in the liquid (B) is not particularly limited. The upper limit of the content of the second organic solvent in the liquid (B) is preferably 50% by mass or less, more preferably 40% by mass or less, and further preferably 30% by mass or less, from the viewpoint of further increasing the silica particle concentration in the reaction liquid and further improving productivity. The content of the second organic solvent in the liquid (B) is preferably 2% by mass or more and 50% by mass or less, more preferably 5% by mass or more and 40% by mass or less, and further preferably 10% by mass or more and 30% by mass or less.

The method for producing the liquid (B) is not particularly limited. The method for producing the liquid (B) is preferably a method in which the alkoxysilane or the like and if necessary, other components are mixed with the second organic solvent while stirring, from the viewpoint of miscibility.

The method for adding the liquid (B) in mixing the liquid (B) with the liquid (A) is not particularly limited, and a method such as a continuous addition method or a divided addition method (e.g., dropping) may be used.

The rate of addition of the liquid (B) in mixing the liquid (B) with the liquid (A) is not particularly limited, and may be appropriately adjusted within a range of not generating a gelatinous material.

The temperatures of the liquid (A) and the liquid (B) as well as the reaction liquid are not particularly limited, and for example, 5° C. or more and 100° C. or less, and preferably 5° C. or more and 70° C. or less. The temperatures of the liquid (A) and the liquid (B) as well as the reaction liquid are preferably the same.

The hydrolysis and polycondensation reaction in the reaction liquid may be performed under any of the pressure conditions of reduced pressure, ordinary pressure, and increased pressure. However, it is preferably conducted under ordinary pressure from the viewpoint of production costs.

The synthesized colloidal silica (the raw material liquid containing colloidal silica particles) may be used in the preparation of the liquid according to the present aspect, the preparation of the surface-modified colloidal silica particles described below, and the like, as it is. The synthesized colloidal silica (the raw material liquid containing colloidal silica particles) may be subjected to treatment such as water substitution and concentration. For the water substitution and concentration, a conventionally known method may be used.

The colloidal silica particles may be unmodified colloidal silica particles or surface-modified colloidal silica particles.

In one embodiment, the colloidal silica particles may include surface-modified colloidal silica particles. The surface-modified colloidal silica particles may be anion-modified colloidal silica particles or cation-modified colloidal silica particles. Examples of the anion-modified colloidal silica particles include colloidal silica in which anionic groups such as sulfonic acid groups, carboxylic acid groups, phosphonic acid groups, and aluminic acid groups are immobilized on the surface. Examples of the cation-modified colloidal silica particles include colloidal silica in which cationic groups such as amino groups are immobilized on the surface.

In a preferred embodiment, the colloidal silica particles include anion-modified colloidal silica particles, more preferably sulfonic acid-modified colloidal silica particles, and further preferably sulfonic acid-modified colloidal silica particles.

Examples of the method for producing the anion-modified colloidal silica particles include, but are not particularly limited to, a method for allowing a silane coupling agent having an anionic group at an end to react with colloidal silica particles.

Specifically, when sulfonic acid groups are immobilized on the colloidal silica particles, it can be performed by, for example, the method described in “Sulfonic acid-functionalized silica through quantitative oxidation of thiol groups”, Chem. Commun. 246-247 (2003). Specifically, by coupling a silane coupling agent having a thiol group, such as 3-mercaptopropyl trimethoxysilane, with the colloidal silica particles and then oxidizing the thiol group with hydrogen peroxide, a liquid containing colloidal silica particles in which sulfonic acid groups are immobilized on the surface (sulfonic acid-modified colloidal silica particles) can be obtained.

When carboxy groups are immobilized on the colloidal silica particles, it can be performed by, for example, the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, by coupling a silane coupling agent containing a photoreactive 2-nitrobenzyl ester with the colloidal silica particles and then subjecting the colloidal silica particles to photoirradiation, a liquid containing colloidal silica particles in which carboxy groups are immobilized on the surface (carboxylic acid-modified colloidal silica particles) can be obtained.

Examples of the method for producing the cation-modified colloidal silica particles include, but are not particularly limited to, a method for immobilizing a silane coupling agent having an amino group, such as aminoethyltrimethoxysilane, aminopropyltrimethoxysilane, aminoethyltriethoxysilane, aminopropyltriethoxysilane, aminopropyldimethylethoxysilane, aminopropylmethyldiethoxysilane, aminobutyltriethoxysilane, as described in Japanese unexamined Patent Application Publication No. 2005-162533, on the surface of silica particles. Consequently, the colloidal silica particles in which amino groups are immobilized on the surface (amino group-modified colloidal silica particles) can be obtained.

The average secondary particle size of the colloidal silica particles is not particularly limited. The lower limit of the average secondary particle size of the colloidal silica particles is preferably 10 nm or more, more preferably 20 nm or more, and further preferably 30 nm or more. The upper limit of the average secondary particle size of the colloidal silica particles is preferably 700 nm or less, more preferably 350 nm or less, and further preferably 220 nm or less. The average secondary particle size of the colloidal silica particles is preferably 10 nm or more and 700 nm or less, more preferably 20 nm or more and 350 nm or less, and further preferably 30 nm or more and 220 nm or less.

The average secondary particle size of the colloidal silica particles can be measured by, for example, a dynamic light scattering method represented by a laser diffraction scattering method. That is, the average secondary particle size of the colloidal silica particles corresponds to the particle diameter D50, when the integrated particle mass from the fine particle side reaches 50% of the total particle mass, in the particle size distribution of abrasive grains determined by the laser diffraction scattering method.

The size of the colloidal silica particles (such as the average secondary particle size) may be suitably controlled by, for example, selecting the synthesis method of colloidal silica (the raw material liquid containing colloidal silica particles).

The shape of the colloidal silica particles is not particularly limited, and may be a spherical shape or a non-spherical shape. Examples of the non-spherical shape include, but are not particularly limited to, various shapes such as polyangular shapes such as a triangular prism or a quadrangular prism, a cylindrical shape, a straw bag-like shape in which the center portion of a cylinder is more swollen than the end part thereof, a donut shape in which the center portion of a disk is penetrated, a plate shape, a so-called cocoon shape having a constriction at the center portion, a so-called associated spherical shape in which a plurality of particles is integrated, a so-called konpeito shape having a plurality of protrusions on its surface, and a rugby ball shape.

The content (concentration) of the colloidal silica particles is not particularly limited, as long as it is a content suitable for ion exchange. The content of the colloidal silica particles is, for example, 1% by mass or more and 40% by mass or less, preferably 5% by mass or more and 30% by mass or less, and more preferably 15% by mass or more and 25% by mass or less based on the total mass of the liquid containing colloidal silica particles and hydrogen peroxide.

In the liquid according to the present aspect, the zeta potential of the colloidal silica particles is not particularly limited. The upper limit of the zeta potential of the colloidal silica particles is, for example, −20 mV or less. The lower limit of the zeta potential of the colloidal silica particles may be, for example, −65 mV or more or −50 mV or more.

The liquid according to the present aspect contains hydrogen peroxide.

The content (concentration) of hydrogen peroxide is not particularly limited. The lower limit of the content of hydrogen peroxide is, for example, 50 ppm by mass (0.005% by mass) or more, preferably 80 ppm by mass (0.008% by mass) or more, and more preferably 100 ppm by mass (0.01% by mass) or more based on the total mass of the liquid containing colloidal silica particles and hydrogen peroxide. The lower limit of the content of hydrogen peroxide may be 200 ppm by mass (0.02% by mass) or more, or 350 ppm by mass (0.035% by mass) or more based on the total mass of the liquid containing colloidal silica particles and hydrogen peroxide. The upper limit of the content of hydrogen peroxide is, for example, 10000 ppm by mass (1% by mass) or less, preferably 7000 ppm by mass (0.7% by mass) or less, and more preferably 5000 ppm by mass (0.5% by mass) or less based on the total mass of the liquid containing colloidal silica particles and hydrogen peroxide. The upper limit of the content of hydrogen peroxide may be 1000 ppm by mass (0.1% by mass) or less, 500 ppm by mass (0.05% by mass) or less, or 400 ppm by mass (0.04% by mass) or less based on the total mass of the liquid containing colloidal silica particles and hydrogen peroxide. The content of hydrogen peroxide is, for example, 50 ppm by mass (0.005% by mass) or more and 10000 ppm by mass (1% by mass) or less, preferably 80 ppm by mass (0.008% by mass) or more and 7000 ppm by mass (0.7% by mass) or less, and more preferably 100 ppm by mass (0.01% by mass) or more and 5000 ppm by mass (0.5% by mass) or less based on the total mass of the liquid containing colloidal silica particles and hydrogen peroxide. As the content (concentration) of hydrogen peroxide, a value calculated from the amount of hydrogen peroxide used may be employed, or a value measured by the method described in Examples may be employed.

The liquid containing colloidal silica particles and hydrogen peroxide contains a by-product produced by a reaction between hydrogen peroxide and the residue of the components used in the production step of the colloidal silica particles, the production step of the surface-modified colloidal silica particles, and the like.

As used herein, “the residue of the components used in the production step of the colloidal silica particles, the production step of the surface-modified colloidal silica particles, and the like” is also simply referred to as “the residue according to the present aspect”.

As used herein, the by-product produced by the reaction between hydrogen peroxide and the residue according to the present aspect is also simply referred to as “the by-product”.

Examples of the residue according to the present aspect include organic solvents, alkali catalysts, and silane coupling agents. The organic solvent is used in the synthesis of the colloidal silica particles, the production of the surface-modified colloidal silica particles, and the like. Examples of the organic solvent include alcohols such as methanol, ethanol, n-propanol, isopropanol, ethylene glycol, propylene glycol, and 1,4-butanediol; and ketones such as acetone and methyl ethyl ketone.

In one embodiment, the residue according to the present aspect contains methanol, and the by-product produced by the reaction between hydrogen peroxide and methanol contains formaldehyde. The production of formaldehyde can be confirmed by measuring the content (concentration) of formaldehyde.

In the liquid according to the present aspect, the lower limit of the content (concentration) of formaldehyde may be 1.0 ppm by mass (0.0001% by mass) or more, 3.0 ppm by mass (0.0003% by mass) or more, 4.0 ppm by mass (0.0004% by mass) or more, 5.0 ppm by mass (0.0005% by mass) or more, or 6.0 ppm by mass (0.0006% by mass) or more based on the total mass of the liquid containing colloidal silica particles and hydrogen peroxide. The upper limit of the content (concentration) of formaldehyde may be 30.0 ppm by mass (0.003% by mass) or less, 25.0 ppm by mass (0.0025% by mass) or less, 15.0 ppm by mass (0.0015% by mass) or less, 10.0 ppm by mass (0.001% by mass) or less, or 8.0 ppm by mass (0.0008% by mass) or less based on the total mass of the liquid containing colloidal silica particles and hydrogen peroxide. The content of formaldehyde may be 1.0 ppm by mass (0.0001% by mass) or more and 30.0 ppm by mass (0.003% by mass) or less, 3.0 ppm by mass (0.0003% by mass) or more and 25.0 ppm by mass (0.0025% by mass) or less, 4.0 ppm by mass (0.0004% by mass) or more and 15.0 ppm by mass (0.0015% by mass) or less, 5.0 ppm by mass (0.0005% by mass) or more and 10.0 ppm by mass (0.001% by mass) or less, or 6.0 ppm by mass (0.0006% by mass) or more and 8.0 ppm by mass (0.0008% by mass) or less based on the total mass of the liquid containing colloidal silica particles and hydrogen peroxide. As the content (concentration) of formaldehyde, a value measured by the method described in Examples is employed.

The liquid according to the present aspect contains a dispersing medium for dispersing respective components. Examples of the dispersing medium include water; alcohols such as methanol, ethanol, and ethylene glycol; ketones such as acetone; and mixtures thereof. The water is preferably water containing impurities as little as possible. Specifically, water is more preferably water obtained by removing impurity ions with an ion exchange resin, and then removing foreign substances through a filter (pure water or ultrapure water), or distilled water.

The method for preparing the liquid containing colloidal silica particles and hydrogen peroxide is not particularly limited. The liquid containing colloidal silica particles and hydrogen peroxide may be prepared by, for example, mixing a raw material liquid containing colloidal silica particles and hydrogen peroxide water so that the colloidal silica particles and hydrogen peroxide achieve desired concentrations. When the colloidal silica particles contain sulfonic acid-modified colloidal silica particles and hydrogen peroxide is used in the step of producing the sulfonic acid-modified colloidal silica particles, a liquid containing the sulfonic acid-modified colloidal silica particles may be used as the liquid containing colloidal silica particles and hydrogen peroxide.

In the ion exchange step, a liquid containing colloidal silica particles and hydrogen peroxide is brought into contact with an ion exchange resin. Consequently, at least a part of the by-product in the liquid containing colloidal silica particles and hydrogen peroxide can be removed. In a preferred embodiment, the ion exchange step includes removing at least a part of formaldehyde in the liquid containing colloidal silica particles and hydrogen peroxide.

Removing at least a part of the by-product in the liquid containing colloidal silica particles and hydrogen peroxide means that the content of the by-product in the dispersion liquid containing colloidal silica particles after the ion exchange step is reduced as compared with the content of the by-product in the liquid containing colloidal silica particles and hydrogen peroxide.

Specifically, removing at least a part of the by-product in the liquid containing colloidal silica particles and hydrogen peroxide means that the reduction rate of the content of the by-product is 15% or more. The reduction rate of the content of the by-product can be calculated using the following equation:

$$the reduction rate of the content of the by - product ( \% ) = ( ( A - B ) / A ) \times 100$$

A: the content of the by-product (ppm by mass) in the liquid containing colloidal silica particles and hydrogen peroxide

B: the content of the by-product (ppm by mass) in the dispersion liquid containing colloidal silica particles.

When the by-product is formaldehyde, the reduction rate of the content of formaldehyde is 15% or more, preferably 30% or more, more preferably 60% or more, further preferably 75% or more, further more preferably 85% or more, and particularly preferably 95% or more (the upper limit: 100%).

Examples of the ion exchange resin include, but are not particularly limited to, cation exchange resins such as strongly acidic cation exchange resins and weakly acidic cation exchange resins; and anion exchange resins such as strongly basic anion exchange resins (strongly basic I-type anion exchange resins and strongly basic II-type anion exchange resins), and weakly basic anion exchange resins.

Examples of the exchange group in the strongly acidic cation exchange resin include a sulfonic acid group. Examples of the exchange group in the weakly acidic cation exchange resin include a carboxy group and a phenolic hydroxyl group.

Examples of the exchange group in the strongly basic I-type anion exchange resin include a trimethylammonium group. Examples of the exchange group in the strongly basic II-type anion exchange resin include a dimethylethanol ammonium group. Examples of the exchange group in the weakly basic anion exchange resin include polyamine and tertiary amine.

When the by-product is formaldehyde, the ion exchange resin is preferably the anion exchange resin, more preferably the strongly basic I-type anion exchange resin or the weakly basic anion exchange resin, and further preferably the strongly basic I-type anion exchange resin, from the viewpoint of capable of further removing formaldehyde.

As the ion exchange resin, a commercial product may be used. Examples of the commercial product include Duolite (registered trademark) series (manufactured by DuPont), DIAION (registered trademark) series (manufactured by Mitsubishi Chemical Corporation), SGC650 (manufactured by Purolite), and Amberlite (registered trademark) and Amberjet (registered trademark) (manufactured by ORGANO CORPORATION).

The method for bringing the liquid containing colloidal silica particles and hydrogen peroxide into contact with the ion exchange resin is not particularly limited, and a conventionally known method may be used. Examples thereof include a method for mixing the liquid containing colloidal silica particles and hydrogen peroxide and the ion exchange resin, and a method for allowing the liquid containing colloidal silica particles and hydrogen peroxide to pass through a column packed with the ion exchange resin.

When the liquid containing colloidal silica particles and hydrogen peroxide and the ion exchange resin are mixed, the amount of the ion exchange resin used may be appropriately adjusted according to the content of the colloidal silica particles in the liquid containing colloidal silica particles and hydrogen peroxide. The lower limit of the amount of the ion exchange resin used is, for example, 1 part by mass or more, preferably 3 parts by mass or more, and more preferably 5 parts by mass or more based on 1000 parts by mass of colloidal silica particles. The upper limit of the amount of the ion exchange resin used is, for example, 80 parts by mass or less, preferably 60 parts by mass or less, and more preferably 45 parts by mass or less based on 1000 parts by mass of colloidal silica particles. The amount of the ion exchange resin used is, for example, 1 part by mass or more and 80 parts by mass or less, preferably 3 parts by mass or more and 60 parts by mass or less, and more preferably 5 parts by mass or more and 45 parts by mass or less.

When the strongly basic anion exchange resin is used as the ion exchange resin, the amount of the ion exchange resin used is preferably 5 parts by mass or more and 80 parts by mass or less, more preferably 10 parts by mass or more and 60 parts by mass or less, and further preferably 15 parts by mass or more and 45 parts by mass or less based on 1000 parts by mass of colloidal silica particles.

When the weakly basic anion exchange resin is used as the ion exchange resin, the amount of the ion exchange resin used is preferably 15 parts by mass or more and 80 parts by mass or less, and more preferably 45 parts by mass or more and 60 parts by mass or less based on 1000 parts by mass of colloidal silica particles.

When the liquid containing colloidal silica particles and hydrogen peroxide and the ion exchange resin are mixed (stirred), the temperature during mixing (stirring) is, for example, 10° C. or more and 50° C. or less, and preferably 20° C. or more and 30° C. or less. The mixing (stirring) time is not particularly limited, for example, 10 min or more and 60 min or less, and preferably 20 min or more and 40 min or less. The stirring speed during mixing (stirring) is not particularly limited, and may be appropriately set (e.g., 600 rpm).

After completion of ion exchange, the ion exchange resin is removed by separation to obtain a dispersion liquid containing colloidal silica particles. The method for removing the ion exchange resin by separation is not particularly limited, and for example, the dispersion liquid containing colloidal silica particles can be obtained by performing filtration using a filter paper, precipitating the ion exchange resin by centrifugation or spontaneously precipitating the ion exchange resin, and recovering a supernatant liquid. The content of the colloidal silica particles and the dispersing medium in the dispersion liquid containing colloidal silica particles is the same as the content of the colloidal silica particles and the dispersing medium in the aforementioned liquid according to the present aspect. The content of hydrogen peroxide in the dispersion liquid containing colloidal silica particles is reduced as compared with the content of hydrogen peroxide in the aforementioned liquid according to the present aspect, and the reduction rate varies depending on the type of ion exchange resin to be used, and is, for example, about 1% by mass or more and about 100% by mass or less, preferably 3% by mass or more and 98% by mass or less, and more preferably 50% by mass or more and 96% by mass or less.

In the dispersion liquid containing colloidal silica particles, at least a part of the by-product in the liquid containing colloidal silica particles and hydrogen peroxide is removed. In the ion exchange step, the by-product in the dispersion liquid containing colloidal silica particles is removed depending on the type of by-product until its content reaches a desired content or less. When the by-product is formaldehyde, the formaldehyde in the dispersion liquid containing colloidal silica particles is removed until its content reaches, for example, 6.0 ppm by mass (0.0006% by mass) or less, preferably 3.0 ppm by mass (0.0003% by mass) or less, and further preferably 2.0 ppm by mass (0.0002% by mass) or less, and particularly preferably 1.0 ppm by mass (0.0001% by mass) or less (the lower limit: 0 ppm by mass (0% by mass)) based on the total mass of the dispersion liquid containing colloidal silica particles.

### [Preparation Step]

The method for producing a dispersion liquid containing colloidal silica particles according to the present aspect may include a preparation step of preparing the liquid containing colloidal silica particles and hydrogen peroxide, before the aforementioned ion exchange step.

In the preparation step, the liquid containing colloidal silica particles and hydrogen peroxide is prepared. The composition of the liquid containing colloidal silica particles and hydrogen peroxide, the method for synthesizing colloidal silica particles, and the method for preparing the liquid containing colloidal silica particles and hydrogen peroxide are as mentioned above.

In one embodiment, the preparation step includes synthesizing colloidal silica particles and mixing the synthesized colloidal silica particles and hydrogen peroxide, and preferably includes synthesizing colloidal silica particles by the alkoxide method and mixing the synthesized colloidal silica particles and hydrogen peroxide. The detail of the alkoxide method is as mentioned above.

In one embodiment, the preparation step includes synthesizing colloidal silica particles, modifying the surface of the synthesized colloidal silica particles, and mixing the surface-modified colloidal silica particles and hydrogen peroxide, and preferably includes synthesizing colloidal silica particles by the alkoxide method, modifying the surface of the synthesized colloidal silica particles, and mixing the surface-modified colloidal silica particles and hydrogen peroxide.

In one embodiment, the preparation step includes synthesizing colloidal silica particles and modifying the surface of the synthesized colloidal silica particles with sulfonic acid groups, and preferably includes synthesizing colloidal silica particles by the alkoxide method and modifying the surface of the synthesized colloidal silica particles with sulfonic acid groups.

The preparation step may further include confirming the presence of a by-product in the liquid containing colloidal silica particles and hydrogen peroxide. For the method for confirming the presence of a by-product, a conventionally known method may be appropriately selected depending on the type of by-product. When the by-product is formaldehyde, the preparation step may further include confirming the presence of aldehyde in the liquid containing colloidal silica particles and hydrogen peroxide. The presence of formaldehyde can be confirmed by measuring the content (concentration) of formaldehyde. The content (concentration) of formaldehyde can be measured by the method described in Examples.

### [Application]

The dispersion liquid containing colloidal silica particles produced by the production method according to the present aspect can be used in various applications. In particular, it can be preferably used as an abrasive grain for polishing an object to be polished such as a semiconductor substrate.

### <Polishing Composition>

One aspect of the present disclosure is a polishing composition that contains the dispersion liquid containing colloidal silica particles produced by the aforementioned production method. The colloidal silica particles contained in the dispersion liquid produced by the aforementioned production method can be used as a polishing agent (abrasive grain) to be contained in a polishing composition.

The polishing composition according to the present aspect may consist of the dispersion liquid containing colloidal silica particles produced by the aforementioned production method, or may contain other known components such as dispersing mediums, pH adjusting agents, chelating agents, thickeners, oxidizing agents, dispersants, surface protective agents, wetting agents, surfactants, anticorrosive agents, antiseptic agents, and antifungal agents, in addition to the dispersion liquid containing colloidal silica particles produced by the aforementioned production method. The content of other components is only required to be appropriately set depending on the purpose of addition.

The object to be polished, which is polished by the polishing composition according to the present aspect, is not particularly limited, and examples thereof include single crystal silicon, polycrystal silicon (polysilicon), polycrystal silicon doped with n-type or p-type impurities, amorphous silicon, amorphous silicon doped with n-type or p-type impurities, silicon oxide, silicon nitride, silicon carbonitride (SiCN), metals, SiGe, carbon-containing materials, and low dielectric materials (Low-k materials).

Examples of the polishing method using the polishing composition according to the present aspect include a polishing method for polishing the aforementioned object to be polished with the polishing composition according to the present aspect.

As the polishing apparatus, a common polishing apparatus equipped with a holder for holding a substrate or the like having an object to be polished, a motor capable of changing the rotation speed, and the like, and having a polishing table to which a polishing pad (polishing cloth) can be attached, can be used.

As the polishing pad, common non-woven fabric, polyurethane, porous fluororesin, or the like can be used without particular limitation. The polishing pad is preferably subjected to grooving such that the polishing liquid accumulates therein.

With respect to the polishing conditions, for example, the rotational speed of the polishing table (platen) and the carrier (head) is preferably 10 rpm (0.17 s⁻¹) or more and 500 rpm (8.33 s⁻¹) or less. The pressure (polishing pressure) applied to the substrate having an object to be polished is preferably 0.5 psi (3.45 kPa) or more and 10 psi (68.9 kPa) or less.

The method for supplying the polishing composition to the polishing pad is also not particularly limited, and for example, a continuous supply method with a pump or the like is employed. The supplying rate is not limited, but it is preferable that the surface of the polishing pad be constantly covered with the polishing composition according to the present aspect.

The polishing composition according to the present aspect may be a one-component type or a multi-component type including a two-component type. The polishing composition according to the present aspect may be prepared by diluting the raw material liquid of the polishing composition to, for example, 3 times or more, using a diluent such as water.

### <Method for Producing Polishing Composition>

One aspect of the present disclosure is a method for producing a polishing composition containing a dispersion liquid containing colloidal silica particles, including producing the dispersion liquid containing colloidal silica particles by the aforementioned method for producing the dispersion liquid.

The method for producing the polishing composition according to the present aspect is not particularly limited. When the dispersion liquid produced by the aforementioned production method is used as the polishing composition, the method for producing the polishing composition according to the present aspect is the same as the aforementioned method for producing a dispersion liquid containing colloidal silica particles.

When the polishing composition contains other components in addition to the dispersion liquid produced by the aforementioned production method, the method for producing the polishing composition according to the present aspect includes mixing the dispersion liquid produced by the aforementioned production method and other components while stirring. The temperature during mixing while stirring is not particularly limited, and is for example, 10° C. or more and 40° C. or less. With respect to the temperature during mixing while stirring, the polishing composition may be heated to increase the rate of dissolution. The time for mixing while stirring is not particularly limited.

The present disclosure includes the following aspects and embodiments.

[1] A method for producing a dispersion liquid containing colloidal silica particles, the method including an ion exchange step of bringing a liquid containing colloidal silica particles and hydrogen peroxide into contact with an ion exchange resin.
[2] The method for producing the dispersion liquid according to the above [1], the method including a preparation step of preparing the liquid containing colloidal silica particles and hydrogen peroxide, before the ion exchange step.
[3] The method for producing the dispersion liquid according to the above [1] or [2], wherein the colloidal silica particles are silica particles produced by an alkoxide method.
[4] The method for producing the dispersion liquid according to any one of the above [1] to [3], wherein the ion exchange resin is an anion exchange resin.
[5] The method for producing the dispersion liquid according to any one of the above [1] to [4], wherein the colloidal silica particles include anion-modified colloidal silica particles.
[6] The method for producing the dispersion liquid according to any one of the above [1] to [5], wherein the colloidal silica particles include sulfonic acid-modified colloidal silica particles.
[7] The method for producing the dispersion liquid according to the above [4], wherein the anion exchange resin is a strongly basic anion exchange resin.
[8] The method for producing the dispersion liquid according to any one of the above [1] to [7], wherein the ion exchange step includes removing at least a part of formaldehyde in the liquid containing colloidal silica particles and hydrogen peroxide.
[9] A polishing composition including the dispersion liquid produced by the production method according to any one of the above [1] to [8].
[10] A method for producing a polishing composition including a dispersion liquid containing colloidal silica particles, the method including producing the dispersion liquid containing colloidal silica particles by the production method according to any one of the above [1] to [8].

### EXAMPLES

The present disclosure will be described further in detail by way of the following Examples and Comparative Example. However, the technical scope of the present disclosure is not limited to the following Examples only. Unless otherwise indicated, “%” and “part” mean “% by mass” and “part by mass”, respectively. In the following Examples, unless otherwise indicated, operations were performed under the conditions of room temperature (20° C. or more and 25° C. or less)/relative humidity of 40% RH or more and 50% RH or less.

### <Preparation of Liquid 1 Containing Colloidal Silica Particles and Hydrogen Peroxide>

To a mixed liquid obtained by mixing 2180.8 g of pure water, 508.6 g of 29% by mass aqueous ammonia (alkali catalyst), and 12391 g of methanol, a mixed liquid obtained by mixing 1522.2 g of tetramethoxysilane and 413.0 g of methanol was added dropwise over 25 minutes while maintaining the liquid temperature at 20° C. to obtain a raw material liquid containing colloidal silica particles in which water and methanol were used as the dispersing medium.

To the raw material liquid containing colloidal silica particles obtained above, 30% by mass aqueous hydrogen peroxide was added so that the final concentration of hydrogen peroxide was 100 ppm by mass, thereby preparing a liquid 1 containing colloidal silica particles and hydrogen peroxide (the content of colloidal silica particles: 19.6% by mass). In the liquid 1 containing colloidal silica particles and hydrogen peroxide, the content of formaldehyde was measured, and the production of formaldehyde was confirmed.

### <Preparation of Liquid 2 Containing Colloidal Silica Particles and Hydrogen Peroxide>

Liquid 2 containing colloidal silica particles and hydrogen peroxide was prepared in the same manner as the liquid 1 containing colloidal silica particles and hydrogen peroxide, except that the final concentration of hydrogen peroxide was changed to 1000 ppm by mass (the content of colloidal silica particles: 19.5% by mass). In the liquid 2 containing colloidal silica particles and hydrogen peroxide, the content of formaldehyde was measured, and the production of formaldehyde was confirmed.

### <Preparation of Liquid 3 Containing Colloidal Silica Particles and Hydrogen Peroxide>

Liquid 3 containing colloidal silica particles and hydrogen peroxide was prepared in the same manner as the liquid 1 containing colloidal silica particles and hydrogen peroxide, except that the final concentration of hydrogen peroxide was changed to 5000 ppm by mass (the content of colloidal silica particles: 19.3% by mass). In the liquid 3 containing colloidal silica particles and hydrogen peroxide, the content of formaldehyde was measured, and the production of formaldehyde was confirmed.

### <Preparation of Liquid 4 Containing Colloidal Silica Particles and Hydrogen Peroxide>

To a mixed liquid obtained by mixing 869.3 g of pure water, 704.6 g of 29% by mass aqueous ammonia (alkali catalyst), and 12924 g of methanol, a mixed liquid obtained by mixing 1522.2 g of tetramethoxysilane and 413.0 g of methanol was added dropwise over 55 minutes while maintaining the liquid temperature at 35° C. to obtain a raw material liquid containing colloidal silica particles in which water and methanol were used as the dispersing medium.

The raw material liquid containing colloidal silica particles obtained above was concentrated while heating to 5000 mL under ordinary pressure. To this concentrated liquid, 6.0 g of 3-mercaptopropyl trimethoxysilane was added as a silane coupling agent, and the mixture was refluxed at the boiling point to perform heat aging. Thereafter, methanol and ammonia were substituted with water while adding pure water to maintain the capacity constant, and the liquid temperature of the concentrated liquid was once reduced to room temperature at the timepoint where the pH reached 8 or less. Then, 62.4 g of 30% by mass aqueous hydrogen peroxide was added, and the mixture was heated again, allowed to continuously react for 8 hours, and cooled to room temperature to obtain a reaction liquid containing sulfonic acid-modified colloidal silica particles.

Then, the reaction liquid obtained above was allowed to stand still overnight for cooling, 0.0343 g (3 mol per 1 mol of the silane coupling agent) of 30% by mass aqueous hydrogen peroxide was added, and the mixture was boiled again. Thereafter, substitution with pure water was performed for 2 hours, and the mixture was cooled to room temperature (25° C.) to prepare a liquid 4 containing colloidal silica particles (sulfonic acid-modified colloidal silica particles) and hydrogen peroxide (the content of colloidal silica particles: 20.0% by mass). In the liquid 4 containing colloidal silica particles and hydrogen peroxide, the content of formaldehyde was measured, and the production of formaldehyde was confirmed.

### <Preparation of Liquid 5 Containing Colloidal Silica Particles and Hydrogen Peroxide>

To a mixed liquid obtained by mixing 2271.4 g of pure water, 508.6 g of 26% by mass aqueous ammonia (alkali catalyst), and 12391 g of methanol, a mixed liquid obtained by mixing 1522.2 g of tetramethoxysilane and 413.0 g of methanol was added dropwise over 25 minutes while maintaining the liquid temperature at 20° C. to obtain a raw material liquid containing colloidal silica particles in which water and methanol were used as the dispersing medium.

The raw material liquid containing colloidal silica particles obtained above was concentrated while heating to 2500 mL under ordinary pressure. To this concentrated liquid, 6.0 g of 3-mercaptopropyl trimethoxysilane was added as a silane coupling agent, and the mixture was refluxed at the boiling point to perform heat aging. Thereafter, methanol and ammonia were substituted with water while adding pure water to maintain the capacity constant, and the liquid temperature of the concentrated liquid was once reduced to room temperature at the timepoint where the pH reached 8 or less. Then, 32.6 g of 30% by mass aqueous hydrogen peroxide was added, and the mixture was heated again, allowed to continuously react for 8 hours, and cooled to room temperature to obtain a reaction liquid containing sulfonic acid-modified colloidal silica particles.

Then, the reaction liquid obtained above was allowed to stand still overnight for cooling, 0.0343 g (3 mol per 1 mol of the silane coupling agent) of 30% by mass aqueous hydrogen peroxide was added, and the mixture was boiled again. Thereafter, substitution with pure water was performed for 2 hours, and the mixture was cooled to room temperature (25° C.) to prepare a liquid 5 containing colloidal silica particles (sulfonic acid-modified colloidal silica particles) and hydrogen peroxide (the content of colloidal silica particles: 20.0% by mass). In the liquid 5 containing colloidal silica particles and hydrogen peroxide, the content of formaldehyde was measured, and the production of formaldehyde was confirmed.

### <Method for Measuring Various Physical Properties>

In the liquids 1 to 5 containing colloidal silica particles and hydrogen peroxide, various physical properties were measured by the following methods.

### (Average Secondary Particle Size)

The average secondary particle size of the colloidal silica particles was measured by a light scattering method using laser light. As the measurement equipment, a dynamic light scattering particle size distribution analyzer UPA-UT151 manufactured by NIKKISO CO., LTD. was used.

### (Zeta Potential)

The liquid containing colloidal silica particles and hydrogen peroxide was subjected to Zetasizer Nano manufactured by Malvern Panalytical Ltd, and the measurement was performed by the laser Doppler method (electrophoretic light scattering measurement method) using a flow cell at a measurement temperature of 25° C. By analyzing the obtained data by the equation of Smoluchowski, the zeta potential of the colloidal silica particles contained in the liquid containing colloidal silica particles and hydrogen peroxide was calculated.

### (Content of Hydrogen Peroxide)

The content of hydrogen peroxide in the liquids 1 to 3 containing colloidal silica particles and hydrogen peroxide was calculated from the amount of the 30% by mass aqueous hydrogen peroxide used.

For the liquids 4 and 5 containing colloidal silica particles and hydrogen peroxide, the content of hydrogen peroxide was measured by using an automatic potentiometric titrator COM-1700 manufactured by Hiranuma Sangyo Co., Ltd. Specifically, to 50 g of the liquid containing colloidal silica particles and hydrogen peroxide (liquid 4 or liquid 5), 100 g of water was added to obtain a mixed liquid A. Then, to the mixed liquid A, 10 g of a 10% by mass aqueous sulfuric acid solution was added to obtain an evaluation solution. Using an aqueous potassium permanganate solution with a factor of 1.0 (0.02 mol/L) as a titration solution, the titration of the evaluation solution was performed, and the content of hydrogen peroxide was determined from the titration amount of the aqueous potassium permanganate solution.

### (Content of Formaldehyde)

The liquid containing colloidal silica particles and hydrogen peroxide was centrifuged (25° C., 365710 G, 10 minutes), and a supernatant liquid was collected. To 10 mL of the supernatant liquid diluted to 10 times, 0.2 mL of a solution obtained by diluting 85% phosphoric acid with water to 5 times was added, and 0.5 mL of a solution of 2,4-dinitrophenylhydrazine in acetonitrile (1 mg/mL) was further added and mixed. Thereafter, the mixture was allowed to stand still for 20 minutes to obtain a test liquid.

The content of formaldehyde was determined by measuring the test liquid using high-performance liquid chromatography (HPLC) under the following conditions:

### HPLC Measurement Conditions

Column: InertSustain C18 (reverse-phase column)
Eluent: acetonitrile/H₂O=50/50
Flow rate: 1 mL/min
Detection: UV 360 nm.

For the liquids 1 to 5 containing colloidal silica particles and hydrogen peroxide, Table 1 shows the average secondary particle size, content, surface-modified group, and zeta potential of the colloidal silica particles, as well as the content of hydrogen peroxide and the content of formaldehyde in the liquid containing colloidal silica particles and hydrogen peroxide.

TABLE 1

| | Colloidal silica particles | | | | | |
|---|---|---|---|---|---|---|
| Liquid containing | Average | | | | Hydrogen | |
| colloidal silica | secondary | Content | Surface- | Zeta | peroxide | Formaldehyde |
| particles and | particle size | [% by | modified | potential | content | content |
| hydrogen peroxide | [nm] | mass] | group | [mV] | [ppm by mass] | [ppm by mass] |
| 1 | 70 | 19.6 | None | −35 | 100 | 4.2 |
| 2 | 70 | 19.5 | None | −35 | 1000 | 20.3 |
| 3 | 70 | 19.3 | None | −35 | 5000 | 28.8 |
| 4 | 35 | 20.0 | Sulfonic acid | −28 | 370 | 6.4 |
| | | | group | | | |
| 5 | 70 | 20.0 | Sulfonic acid | −45 | 242 | 7.8 |
| | | | group | | | |

### Example 1

To the liquid 1 containing colloidal silica particles and hydrogen peroxide, 45 g of a strongly basic I-type anion exchange resin (Duolite (registered trademark) HPR550(OH), manufactured by DuPont) per 1000 g of the colloidal silica particles was added, and the mixture was stirred at 25° C. and 600 rpm for 30 minutes to perform ion exchange. After completion of ion exchange, filtration using a filter paper was performed, and a supernatant liquid was recovered to obtain a dispersion liquid containing colloidal silica particles.

### Example 2

A dispersion liquid containing colloidal silica particles was obtained in the same manner as in Example 1, except that the liquid 2 containing colloidal silica particles and hydrogen peroxide was used instead of the liquid 1 containing colloidal silica particles and hydrogen peroxide.

### Example 3

A dispersion liquid containing colloidal silica particles was obtained in the same manner as in Example 1, except that the liquid 3 containing colloidal silica particles and hydrogen peroxide was used instead of the liquid 1 containing colloidal silica particles and hydrogen peroxide.

### Example 4

A dispersion liquid containing colloidal silica particles was obtained in the same manner as in Example 1, except that the liquid 4 containing colloidal silica particles and hydrogen peroxide was used instead of the liquid 1 containing colloidal silica particles and hydrogen peroxide, and 5 g of a strongly basic I-type anion exchange resin (Duolite (registered trademark) HPR550(OH), manufactured by DuPont) per 1000 g of the colloidal silica particles was added.

### Example 5

A dispersion liquid containing colloidal silica particles was obtained in the same manner as in Example 4, except that 10 g of a strongly basic I-type anion exchange resin (Duolite (registered trademark) HPR550(OH), manufactured by DuPont) per 1000 g of the colloidal silica particles was added.

### Example 6

A dispersion liquid containing colloidal silica particles was obtained in the same manner as in Example 4, except that 15 g of a strongly basic I-type anion exchange resin (Duolite (registered trademark) HPR550(OH), manufactured by DuPont) per 1000 g of the colloidal silica particles was added.

### Example 7

A dispersion liquid containing colloidal silica particles was obtained in the same manner as in Example 4, except that 45 g of a strongly basic I-type anion exchange resin (Duolite (registered trademark) HPR550(OH), manufactured by DuPont) per 1000 g of the colloidal silica particles was added.

### Example 8

A dispersion liquid containing colloidal silica particles was obtained in the same manner as in Example 6, except that a weakly basic anion exchange resin (DIAION (registered trademark) WA20, manufactured by Mitsubishi Chemical Corporation) was used instead of the strongly basic I-type anion exchange resin (Duolite (registered trademark) HPR550(OH), manufactured by DuPont).

### Example 9

A dispersion liquid containing colloidal silica particles was obtained in the same manner as in Example 8, except that 45 g of a weakly basic anion exchange resin (DIAION (registered trademark) WA20, manufactured by Mitsubishi Chemical Corporation) per 1000 g of the colloidal silica particles was added.

### Example 10

A dispersion liquid containing colloidal silica particles was obtained in the same manner as in Example 6, except that a weakly basic anion exchange resin (DIAION (registered trademark) WA30, manufactured by Mitsubishi Chemical Corporation) was added instead of the strongly basic I-type anion exchange resin (Duolite (registered trademark) HPR550(OH), manufactured by DuPont).

### Example 11

A dispersion liquid containing colloidal silica particles was obtained in the same manner as in Example 10, except that 45 g of a weakly basic anion exchange resin (DIAION (registered trademark) WA30, manufactured by Mitsubishi Chemical Corporation) per 1000 g of the colloidal silica particles was added.

### Example 12

A dispersion liquid containing colloidal silica particles was obtained in the same manner as in Example 1, except that the liquid 5 containing colloidal silica particles and hydrogen peroxide was used instead of the liquid 1 containing colloidal silica particles and hydrogen peroxide.

### Comparative Example 1

The liquid 4 containing colloidal silica particles and hydrogen peroxide was prepared as the dispersion liquid containing colloidal silica particles of Comparative Example 1.

### <Method for Measuring Various Physical Properties>

In the dispersion liquids containing colloidal silica particles of Examples and Comparative Example, various physical properties were measured by the following methods.

### (Content of Formaldehyde)

The dispersion liquid containing colloidal silica particles was centrifuged (25° C., 365710 G, 10 minutes), and a supernatant liquid was collected. To 10 mL of the supernatant liquid diluted to 10 times, 0.2 mL of a solution obtained by diluting 85% phosphoric acid with water to 5 times was added, and 0.5 mL of a solution of 2,4-dinitrophenylhydrazine in acetonitrile (1 mg/mL) was further added and mixed. Thereafter, the mixture was allowed to stand still for 20 minutes to obtain a test liquid.

The concentration of formaldehyde was determined by measuring the test liquid using high-performance liquid chromatography (HPLC) under the following conditions:

### HPLC Measurement Conditions

Column: InertSustain C18 (reverse-phase column)
Eluent: acetonitrile/H₂O=50/50
Flow rate: 1 mL/min
Detection: UV 360 nm.

### (Reduction Rate of Content of Formaldehyde)

The reduction rate of the content of formaldehyde was calculated using the following equation:

$$the reduction rate of the content of formaldehyde ( \% ) = ( ( A - B ) / A ) \times 100$$

A: the content of formaldehyde (ppm by mass) in the liquid containing colloidal silica particles and hydrogen peroxide

B: the content of formaldehyde (ppm by mass) in the dispersion liquid containing colloidal silica particles.

For the dispersion liquids containing colloidal silica particles of Examples and Comparative Example, Table 2 shows the type of liquid containing colloidal silica particles and hydrogen peroxide used in the ion exchange, the content of formaldehyde in the liquid containing colloidal silica particles and hydrogen peroxide, the type and exchange group of ion exchange resin, as well as the content of formaldehyde and the reduction rate of the content of formaldehyde after the ion exchange step.

TABLE 2

| | Liquid(*1) | | | | | | |
|---|---|---|---|---|---|---|---|
| | | Content of | | | | | |
| | | formaldehyde | Ion exchange resin | | | Formaldehyde | |
| | | before ion | | | Amount | Content | Reduction |
| | | exchange step | | | used(*2) | [ppm by | rate |
| | Type | [ppm by mass] | Type | Exchange group | [g] | mass] | [%] |
| Example 1 | 1 | 4.2 | Strongly basic I- | Trimethylammonium | 45 | 0.04 | 99 |
| | | | type | group | | | |
| | | | anion exchange | | | | |
| | | | resin | | | | |
| Example 2 | 2 | 20.3 | Strongly basic I- | Trimethylammonium | 45 | 0.41 | 98 |
| | | | type | group | | | |
| | | | anion exchange | | | | |
| | | | resin | | | | |
| Example 3 | 3 | 28.8 | Strongly basic I- | Trimethylammonium | 45 | 1.44 | 95 |
| | | | type | group | | | |
| | | | anion exchange | | | | |
| | | | resin | | | | |
| Example 4 | 4 | 6.4 | Strongly basic I- | Trimethylammonium | 5 | 4.16 | 35 |
| | | | type | group | | | |
| | | | anion exchange | | | | |
| | | | resin | | | | |
| Example 5 | 4 | 6.4 | Strongly basic I- | Trimethylammonium | 10 | 0.77 | 88 |
| | | | type | group | | | |
| | | | anion exchange | | | | |
| | | | resin | | | | |
| Example 6 | 4 | 6.4 | Strongly basic I- | Trimethylammonium | 15 | 0.26 | 96 |
| | | | type | group | | | |
| | | | anion exchange | | | | |
| | | | resin | | | | |
| Example 7 | 4 | 6.4 | Strongly basic I- | Trimethylammonium | 45 | 0.13 | 98 |
| | | | type | group | | | |
| | | | anion exchange | | | | |
| | | | resin | | | | |
| Example 8 | 4 | 6.4 | Weakly basic | Polyamine | 15 | 4.29 | 33 |
| | | | anion exchange | | | | |
| | | | resin | | | | |
| Example 9 | 4 | 6.4 | Weakly basic | Polyamine | 45 | 1.34 | 79 |
| | | | anion exchange | | | | |
| | | | resin | | | | |
| Example 10 | 4 | 6.4 | Weakly basic | Tertiary amine | 15 | 5.38 | 16 |
| | | | anion exchange | | | | |
| | | | resin | | | | |
| Example 11 | 4 | 6.4 | Weakly basic | Tertiary amine | 45 | 2.50 | 61 |
| | | | anion exchange | | | | |
| | | | resin | | | | |
| Example 12 | 5 | 7.8 | Strongly basic I- | Trimethylammonium | 45 | 0.23 | 97 |
| | | | type | group | | | |
| | | | anion exchange | | | | |
| | | | resin | | | | |
| Comparative | 4 | 6.4 | Not used | | | 6.40 | 0 |
| Example 1 | | | | | | | |

*1Type of liquid containing colloidal silica particles and hydrogen peroxide used in the ion exchange step
*2Amount used per 1000 g of the colloidal silica particles in the liquid containing colloidal silica particles and hydrogen peroxide used

As shown in Table 2, the dispersion liquids containing colloidal silica particles of Examples are found to have reduced contents of formaldehyde that is produced by the reaction of hydrogen peroxide and methanol. The dispersion liquids containing colloidal silica particles of Examples are found to have high reduction rates of the content of formaldehyde as compared with that of Comparative Example.

The present application claims priority based on Japanese Patent Application No. 2025-057573 filed on Mar. 31, 2025, which is incorporated herein by reference in its entirety.

1. A method for producing a dispersion liquid containing colloidal silica particles, the method comprising an ion exchange step of bringing a liquid containing colloidal silica particles and hydrogen peroxide into contact with an ion exchange resin.

2. The method for producing the dispersion liquid according to claim 1, the method comprising a preparation step of preparing the liquid containing colloidal silica particles and hydrogen peroxide, before the ion exchange step.

3. The method for producing the dispersion liquid according to claim 1, wherein the colloidal silica particles are colloidal silica particles produced by an alkoxide method.

4. The method for producing the dispersion liquid according to claim 1, wherein the ion exchange resin is an anion exchange resin.

5. The method for producing the dispersion liquid according to claim 1, wherein the colloidal silica particles comprise anion-modified colloidal silica particles.

6. The method for producing the dispersion liquid according to claim 1, wherein the colloidal silica particles comprise sulfonic acid-modified colloidal silica particles.

7. The method for producing the dispersion liquid according to claim 4, wherein the anion exchange resin is a strongly basic anion exchange resin.

8. The method for producing the dispersion liquid according to claim 1, wherein the ion exchange step comprises removing at least a part of formaldehyde in the liquid containing colloidal silica particles and hydrogen peroxide.

9. A polishing composition comprising a dispersion liquid produced by the production method according to claim 1.

10. A method for producing a polishing composition comprising a dispersion liquid containing colloidal silica particles,
the method comprising producing the dispersion liquid containing colloidal silica particles by the production method according to claim 1.
